(19) United States
(12) Patent Application Publication
(10) Pub. No.: US 2020/0130508 A1
(43) Pub. Date: Apr. 30, 2020

(54) METHOD AND CONTROL SYSTEM FOR A VEHICLE HAVING AN ELECTRIC OR A FUEL-CELL DRIVE

(71) Applicant: ZF Friedrichshafen AG, Friedrichshafen (DE)

(72) Inventor: Tomas RIEGER, Überlingen (DE)

(21) Appl. No.: 16/660,062

(22) Filed: Oct. 22, 2019

(30) Foreign Application Priority Data
Oct. 26, 2018 (DE) 10 2018 218 398.8

(51) Int. Cl. B60L 1/12; B60L 50/60; B60L 50/70; B60L 15/20

(52) U.S. Cl. CPC B60L 1/12; B60L 50/60; B60L 2210/10; B60L 15/20; B60L 2210/30; B60L 50/70

(57) ABSTRACT

A method of operating an electric or a fuel cell motor vehicle. The vehicle has an electric machine which can operate as motor or generator and serves as a drive assembly. The electric machine is connected, via an AC/DC converter, to a high-voltage distributor. A high-voltage battery, high-voltage loads, and, via a high-voltage low voltage DC/DC converter, low-voltage loads are connected to the distributor. When the electric machine is operated as a generator in an overrun operation of the vehicle, the electric energy generated by the electric machine is calculated. The high-voltage battery, the high-voltage loads, and possibly the low-voltage loads, are operated, depending on driver and/or non-driver settings, such that the energy produced by electric machine is distributed between the high voltage battery, the high-voltage loads, and, if necessary, the low-voltage loads so as to minimize a difference between the energy produced and consumed by the electric machine.

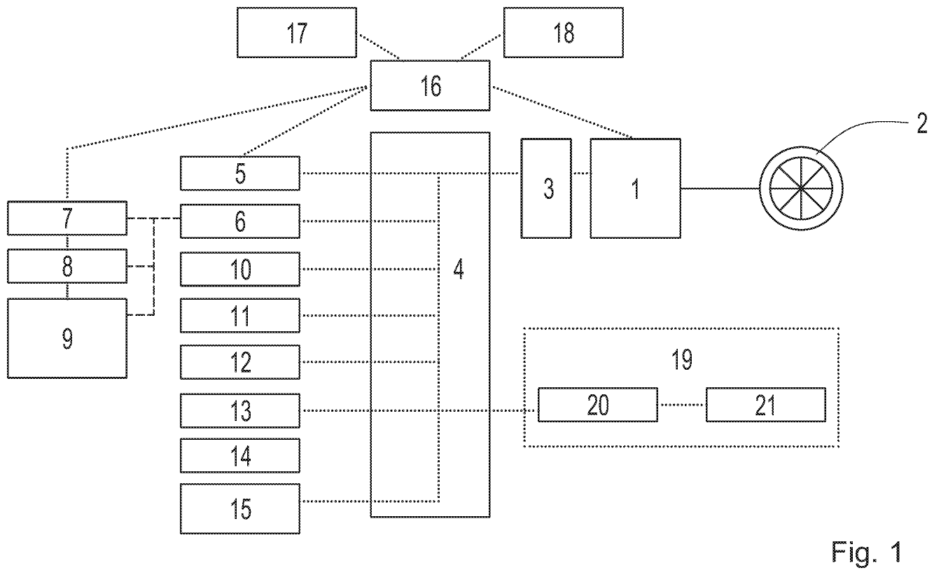

This application claims priority from German patent application serial no. 10 2018 218 398.8 filed Oct. 26, 2018.

### FIELD OF THE INVENTION

The invention concerns a method for operating a motor vehicle which is designed as an electric vehicle or a fuel cell vehicle. In addition, the invention concerns a control system for operating a motor vehicle which is designed as electric vehicle or fuel cell vehicle.

### BACKGROUND OF THE INVENTION

In vehicles which use an electric machine as the drive aggregate, electric energy can be produced if the respective electric machine is operated as generator. The electric energy can be used to charge an electric energy storage. Then when the electric energy storage can no longer accommodate the electric energy which is produced by generator-operated the electric machine, when for instance the electric energy storage is completely charged the excess energy is converted to heat as known from practice in motor vehicles. Hereby, the vehicle has a high-voltage brake resistor in which the electric energy is converted to heat. Such a high-voltage brake resistor is an Ohm's resistor which converts the electric energy into heat. Hereby and so far, a high-voltage brake resistor has relatively large dimensions to even convert the electric energy into heat and to dissipate it when the electric energy storage is completely charged and when the electric machine produces a relatively large electric energy in overrun operation as generator. Such a high-voltage brake resistor not only increases the weight of the motor vehicle but also its cost.

### SUMMARY OF THE INVENTION

Based on the above, the object of the invention is to provide a novel method and control system for operating a motor vehicle designed as an electric vehicle or fuel cell vehicle.

This object is achieved by a method in accordance with the independent patent claim(s).

In accordance with the invention and at that time when the or each electric machine, which serves as drive aggregate, is operated as a generator in the push operation of the motor vehicle, the electric energy producible and/or produced is calculated. In addition, a high-voltage battery, the high-voltage loads, and if necessary the low-voltage loads are operated in a way, dependent on the driver's settings or non-driver settings, that the electric energy which is producible and/or is produced by the or each electric machine is distributed in a way between the high-voltage battery, the high-voltage loads and if necessary the low-voltage loads, that a difference between the producible and/or produced energy by the or each electric machine and the withdrawn energy by the high-voltage battery, the high-voltage loads and if necessary the low-voltage loads is minimized. The invention proposes to process in the overrun operation of the motor vehicle an energy balance and to operate the motor vehicle based on this energy balance. For this energy balance, the producible and/or produced energy in the overrun condition of the motor vehicle by the electric machine operating as generator is calculated. Depending on the driver's settings and dependent on non-driver settings, the high-voltage battery, the high-voltage loads and the low-voltage loads are operated in a way that the producible and/or produced energy by the or each electric machine is optimally distributed so that a difference between the energy, which is producible and/or produced by the or each electric machine and the used energy by the high-voltage battery, the high-voltage loads, and the low-voltage loads is minimal. Thus, a high-voltage brake resistor can now have smaller dimensions.

In a preferred, further embodiment of the invention, the high-voltage batteries, the high-voltage loads, and the low-voltage loads are operated in a way that a difference between the distributed electrical energy and their consumed electrical energy and the producible and/or produced energy by the or each electric machine is zero or almost zero. It is possible hereby to waive completely a high-voltage brake resistor.

In an advantageous further embodiment, depending on the energy which is producible by the or each electric machine, two loads are operated simultaneously which in their opposing effect are at least partially compensating each other. This approach is preferred to completely waive a high-voltage brake resistor.

In an advantageous further embodiment, a driver's drive pedal activation and/or a driver's brake pedal activation and/or a driver's activation of the cruise control is considered. As non-driver settings, a control system's specification of an active cruise control system and/or a control system's specification of a navigation system and/or a control system's specification regarding approved operating conditions of the high voltage battery, the high voltage loads, and the low-voltage loads are considered.

Preferably and at that time when the or each electric machine, which serves as drive aggregate, is operated in the pull condition of the motor vehicle and as a motor, dependent on driver's settings and/or dependent on non-driver settings, the required electric traction energy needed for the or each electric machine is calculated whereby the high-voltage battery, the high-voltage loads, and the low-voltage loads are operated in a way that a difference between the required electric traction energy of the or each electric machine and the actually available electric energy is minimized. The invention can also be used in the pull operation of the motor vehicle to provide hereby in a pull operation of the electric machine preferably as much energy for a conversion to drive power.

The control system in accordance with the invention to operate a motor vehicle designed as an electric vehicle or fuel cell vehicle is defined in the independent claim(s).

### BRIEF DESCRIPTION OF THE DRAWINGS

Preferable further embodiments result from the independent claims and the following description. Embodiment examples of the invention are, but not limited to, further explained based on the drawings.

The sole Figure shows a schematic of a motor vehicle which is designed and as an electric vehicle or fuel-cell vehicle.

### DETAILED DESCRIPTION OF THE PREFERRED EMBODIMENTS

The Figure shows various components of a motor vehicle which is designed as an electric vehicle. Hereby, the motor vehicle comprises of an electric machine 1, which serves as a drive unit to provide drive power at an output 2.

The electric machine 1 which can be operated as motor or generator is connected through an AC/DC converter 3 to a high-voltage distributor 4, which is designed and is a high-voltage DC distributor. Such a high-voltage DC distributor is also called a HV-DC-Link.

Not only is the electric machine 1 connected through the AC/DC converter 3 to the high-voltage distributor 4, but also additional modules are connected to the high-voltage distributor 4, in this case a high-voltage battery 5 which serves as traction battery, a high-voltage low-voltage DC/DC converter 6, as well as different high-voltage loads 10-15, in particular a high-voltage air conditioner 10 and/or a high-voltage heating device 11 and/or a high-voltage battery climate control 12, and/or a high-voltage power take-out 13, and/or a high-voltage pneumatic compressor 14 as well as possibly other high-voltage loads 15. The above mentioned high-voltage loads are typical high-voltage loads of a commercial vehicle. The listing here is of exemplary nature.

Several low-voltage loads 7, 8, 9 are connected to the high-voltage low-voltage DC/DC converter 6, here for instance a low-voltage battery 7, a steering system 8, and if necessary additional low-voltage loads 9.

At that time when during traction operation of the motor vehicle the electric machine 1 is operated as motor, electric energy is provided from the high-voltage battery 5 in order to convert the electric energy into drive power for the output 2. However, when the electric machine 1 is operated as a generator, meaning in the traction mode of the motor vehicle, the produced electric energy by the electric machine 1 is used to charge in particular the high-voltage battery 5.

The Figure shows a control device 16 which serves to operate, namely control and/or regulate the electric machine 1, the high-voltage battery 5, the high-voltage loads 6 to 15, as well as the low-voltage loads 7 to 9. This control device 16 exchanges data with these modules and additional control devices 17 and 18. Driver's settings can be provided by the control device 17, for instance data concerning a driver's drive pedal activation and/or data regarding a driver's brake pedal activation and/or a driver's activation of a cruise control. Non-driver settings can be provided by the control device 18, for instance control settings of an active cruise control system and/or control settings of a navigation system and/or control settings concerning approved operating conditions of the high-voltage battery 5, the high-voltage loads 6 to 15, and or low-voltage loads 7 to 9.

The Figure shows in addition a so-called retarder 19 which comprises a high-voltage brake resistor 21 which is connected through a high-voltage DC/DC converter 20 and the high-voltage distributor 4. With the known motor vehicles in the industry, the retarder 19 serves for the elimination, when the electric machine 1 is operated as generator, of excess energy which can be stored anymore in the high-voltage battery 5, for instance when the high-voltage battery 5 is complete the charged. Such excess electric energy, known with motor vehicles and the industry, is converted to heat in the retarder 19, meaning in its high-voltage brake resistor 21.

It is proposed with the present invention that, at the time when the electric machine 1 serving as drive aggregate is operated in the overrun condition of the motor vehicle as generator, the producible and/or produced energy of the or each electric machine 1 in the actual overrun condition is calculated. Dependent on the rotation speeds and torques at the output 2, as well as the operating conditions of the electric machine 1, the control device 16 can calculate the producible and/or produced energy. Hereby, actual data and predictive or future data, respectively, can be considered.

It is also in the meaning of the invention that the high-voltage battery 5, the high-voltage loads 6 to 15, and preferably also the low-voltage loads 7 to 9, depending of driver's settings and non-driver settings are operated in a way that the producible and/or produced electrical energy of the or each electric machine 1 is distributed according to an energy balance to the high-voltage battery 5, the high-voltage loads 6 to 15, and the low voltage loads 7 to 9, so that a difference of the electric energy which is producible and/or is produced by the electric machine 1 in operation as a generator, and the consumed electric energy which is consumed by the high-voltage battery 5, the high-voltage loads 6 to 15, and the low-voltage loads 7 to 9, is minimized, and preferably amounts to zero.

It is possible with the invention to either have smaller dimensions of the retarder 19 or to completely omit the retarder 19.

In the above energy balance, as already mentioned, the driver's settings and non-driver settings are considered, whereby the driver's settings are provided by the control device 17, the non-driver settings by the control device 18, of the control device 16. Hereby, actual data and predictive data or anticipated data, and thus specifications, can be considered.

The control device 16 controls and/or regulates the provision of the energy balance, the operation of the electric machine 1 and the operation of the modules 5 to 15 in the generator operation of the electric machine 1 to distribute the electric energy generated by the same as possible completely, in particular completely, for the modules 5 to 15 and therefore making the retarder 19 unnecessary. Hereby, the control device 16 receives data from the control devices 17 and 18, meaning the driver's and non-driver settings. Also, the control device 16 exchanges data with the electric machine 1 and the modules 5 to 15 which are required for the operation of the motor vehicle in accordance with the invention. Hereby, the functionality in the shown example is implemented in the control device 16 which is here designed to execute the above described method. Hereby, the control device 16 has data interfaces to exchange data with the components which participate in the inventive method, meaning with the electric machine 1, the modules 5 to 15, as well as the control units 17 and 18. Also, the control device 16 comprises a processor for the data processing and memory for the data storage.

In a concrete application of the invention, it is assumed that the motor vehicle to be operated is a bus. This bus is exclusively driven purely electrically, the drive power at the output drive 2 is therefore exclusively provided by the electric machine 1. The bus can also have several electric machines which are connected through the respective AC/DC converter 3 to the high-voltage distributor 4. The bus comprises a high-voltage battery 5 as traction battery. As an additional high-voltage load, the bus comprises a high-voltage air conditioner 10 to cool down the passenger compartment. Also, the bus comprises as a high-voltage load a high-voltage heating device 11 to heat the passenger compartment. As an additional high-voltage load, the bus can also comprise an air compressor 14 two supply for instance a pneumatic brake with pressured air. In addition, the bus comprises a high-voltage low-voltage DC/DC converter, at which low-voltage loads are connected to, in particular a low-voltage battery 7 and a steering system 8.

At that time when such a bus is operated in push condition during a downhill drive, the or each electric machine 1 is operated as generator in produces hereby electrical energy which is fed through the AC/DC converter 3 into the high-voltage distributor 4. This fed electrical energy is distributed by the control device 16 in a way to be high-voltage battery 5, the high-voltage loads 6 to 15, as well as the low-voltage load 7 to 9, that ail electric energy which is produced by the electric machine 1 is then absorbed by the here energy-lowering modules 5 to 15 so that therefore a difference between the produce electrical energy of the electric machine 1 and the electric energy absorbed by the modules 5 to 15 amounts to zero. Thus, a retarder 19 can be completely waived.

It can be provided in this case that the electric energy which is produced by the electric machine 1 is used to operate two loads simultaneously, each itself opposite in their effect and are least partially compensating, to consume all the energy which is provided by the electric machine 1 during generator operation. As an example it can be provided to operate simultaneously the high-voltage air conditioner 10, which is meant to cool down, and the high-voltage heating device 11, which is meant to heat, whereby the two devices are at least compensate each other. This might be required when, for instance, the passenger compartment of the bus cannot be cooled too far down. Thus and as a non-driver's, control side specification, a temperature within no can be defined for the passenger compartment of the bus in which the temperature needs to fluctuate. Through a much too heavy operation of the high-voltage air conditioner 10, the temperature in the passenger compartment could possibly exit this temperature range or temperature window, respectively. To still operate the high-voltage air conditioner 10 and four the consumption of the produced electric energy of the electric machine 1, a high-voltage heating device 11 can then be operated to keep the temperature in the desired temperature window.

Alternatively or in addition in depending on the design of the high-voltage air conditioner 10, the cooled air is not brought into the passenger compartment but conducted into the environment,

It is provided in an advantageous further embodiment of the invention that at the time when the electric machine 1 is operated as motor in the pull operation of the motor vehicle that then, and dependent on the driver's settings and dependent on non-driver settings, the traction energy is calculated which is required by the or each electric machine 1. As a driver's setting, a respective drive pedal actuation desired by the driver can be considered. As a non-driver setting, a topographic route profile which is provided by a navigation system for the anticipated route can be considered. The high-voltage battery 5, the high-voltage loads 5 to 15, as well as the low-voltage loads 7 to 9 are operated in a way that a difference between the electric traction energy required by the electric machine 1 and the actually provided electric energy is minimized so that hereby the driver's wish can be accommodated.

If for instance there is a high driver's wish present and the electric machine 1 needs a large amount of electric energy due to the driver's wish and, for instance, the high-voltage air conditioner 10 is operated it is possible, depending on the charge condition of the energy storage 5, to reduce the power consumption of the high voltage air conditioner 10 or to completely turning it off, in order to provide as much electric energy as possible for driving the electric machine 1.

As already mentioned, the functionality according to the invention is preferably implemented centrally in the control unit 16. However, the functionality according to the invention can also be decentralized and distributed to several control devices. It is thus possible, for example, that the modules 5 to 15 have their own control devices and decide themselves about theft operation, meaning the amount of electric energy to be consumed thereby.

The invention concerns in addition a control system for operating the motor vehicle. The control system comprises at least the control device 16 in which the inventive method is executed. The control device 16 is designed to execute the above described method in its control.

At the time when the motor vehicle is operated in the overrun condition and the electric machine 1 is operated as generator, the control device 16 calculates the producible and/or produced electric energy of the electric machine 1. In addition, the control device 16 controls the modules 5 to 15 dependent on the driver's settings and dependent on the non-driver settings in a way that the producible and/or produced electric energy by the electric machine is possibly completely consumed by the modules 5 to 15, meaning the distributed to the modules 5 to 15, so that the difference between the produced electric energy and the distributed energy is minimal, in particular it amounts to zero.

The invention is not only limited for the use in electric vehicles, the motor vehicle to be operated can rather be a fuel cell vehicle. The fuel cell produces electric energy and is coupled as an additional module in particular, via a DC/DC converter, to the high voltage distributor 4.

### REFERENCE CHARACTERS

1 Electric Machine
2 Output Drive
3 AC/DC Converter
4 High Voltage Distribution
5 High Voltage Battery
6 High-Low Voltage DC Converter
7 Low Voltage Load
8 Low Voltage Load
9 Low Voltage Load
10 High-Voltage air conditioner
11 High Voltage Heater
12 High Voltage Battery climate control
13 High Voltage Power Take-Out
14 High Voltage Compressor
15 High Voltage Load
16 Control Device
17 Control Device
18 Control Device
19 Retarder
20 High Voltage DC/DC Converter
21 High Voltage Brake Resistor

1-9. (canceled)

10. A method of operating a motor vehicle designed as an electric vehicle or a fuel cell vehicle, the motor vehicle has at least one electric machine (1) that is operable as a drive motor and a generator, the at least one electric machine (1) is connected, via an AC/DC converter, to a high voltage distributor (4), the high voltage distributor (4) is further connected to a high voltage battery (5), which is designed as a traction battery, and high voltage loads, the high voltage loads comprises at least one of a high-voltage air conditioner (10), a high-voltage heating device (11), a high voltage Power-Take-Out (13), a high-voltage compressor (14) and a high-voltage-low-voltage DC/DC converter (6) which is connected to low voltage loads (7, 8, 9), the method comprising:
operating the electric machine (1) as a generator during an overrun operation of the motor vehicle,
determining electrical energy that is at least one of producible and generated by the electric machine (1),
operating the high voltage battery (5), the high voltages loads (6, 10, 11, 12, 13, 14, 15) and, if necessary, the low voltage loads (7, 8, 9), depending on settings determined by a driver such that the electrical energy that is at least one of producible and generated by the electric machine (1) is distributed between the high voltage battery (5), the high-voltage loads (6, 10, 11, 12, 13, 14, 15), and, if necessary, the low voltage loads so that a difference between the electrical energy that is at least one of producible and generated by the electric machine (1) and electrical energy consumed by the high voltage battery (5), the high voltage loads (6, 10, 11, 12, 13, 14, 15), and, if necessary, the low voltage loads (7, 8, 9) is minimized.

11. The method according to claim 10, further comprising operating the high-voltage battery (5), the high-voltage loads (6, 10, 11, 12, 13, 14, 15) and, if necessary, the low-voltage loads (7, 8, 9) such that the difference between the electrical energy that is at least one of producible and generated by the electric machine (1) and the electrical energy consumed by the high voltage battery (5), the high voltage loads (6, 10, 11, 12, 13, 14, 15), and, if necessary, the low voltage loads (7, 8, 9) amounts to substantially zero.

12. The method according to claim 10, further comprising simultaneously operating two partially compensating loads which are reciprocal in their effect depending on the electrical energy that is at least one of producible and generated by the electric machine.

13. The method according to claim 10, further comprising, when the at least one electric machine (1), which serves as the drive motor, is operated in a traction operation of the motor vehicle, and depending on the settings selected by a driver and depending on non-driver settings, calculating traction energy required by the at least one electric machine (1), and operating the high voltage battery (5), the high voltages loads (6, 10, 11, 12, 13, 14, 15), and, if necessary, the low voltage loads (7, 8, 9) such that a difference between required electric traction energy of the at least one electric machine (1) and the electrical energy actually present is minimized.

14. The method according to claim 10, further comprising considering actual data and predictive data during calculation and distribution of the respective electric energy.

15. The method according to claim 10, further comprising considering the settings determined by the driver as being at least one of activation of a drive pedal by the driver, activation of a brake pedal by the driver, and activation of a cruise control by the driver.

16. The method according to claim 13, further comprising considering as the non-driver settings at least one of a control-side setting of an active-cruise-control-system, a control-side setting of a navigation system, a control-side setting regarding permitted operating conditions of the high-voltage battery (5), the high-voltage loads (6, 10, 11, 12, 13, 14, 15), and the low-voltage loads (7, 8, 9).

17. A control system for operating a motor vehicle designed as an electric vehicle or a fuel cell vehicle and having at least one electric machine (1) that is operable as a drive motor and a generator, the at least one electric machine (1) is connected, via an AC/DC converter (3), to a high-voltage distributor (4), the high-voltage distributor (4) is connected to a high-voltage battery (5), which is a traction battery, and high-voltage loads, the high-voltage loads comprising at least one of a high-voltage air conditioner (10), a high-voltage heating device (11), and a high-voltage power take-out (13), a high-voltage compressor (14), and a high-voltage low-voltage DC/DC converter (6) which is connected to low-voltage loads (7, 8, 9),
the control system at a time when the at least one electric machine (1), is operated as the generator in an overrun operation of the motor vehicle calculates electrical energy that is at least one of producible and produced by the at least one electric machine (1), and
the high-voltage battery (5), the high-voltage loads (6, 10, 11, 12, 13, 14, 15) and, if necessary, the low-voltage loads (7, 8, 9), depending on at least one of driver's settings and non-driver settings, are operated such that the electrical energy that is at least one of producible and produced by the at least one electric machine (1) is distributed between the high-voltage battery (5), the high-voltage loads (6, 10, 11, 12, 13, 14, 15), and, if necessary, the low-voltage loads (7, 8, 9) such that a difference between the electrical energy that is at least one of producible and produced by the at least one electric machine (1) and electrical energy consumed by the high-voltage battery (5), the high-voltage loads (6, 10, 11, 12, 13, 14, 15) and, if necessary, the low-voltage loads (7, 8, 9) is minimized.

18. The control system according to claim 17, wherein the control system is configured to execute of a method comprising steps of:
operating the electric machine (1) as the generator during the overrun operation of the motor vehicle,
determining the electrical energy that is at least one of producible and generated by the electric machine (1),
operating the high voltage battery (5), the high voltages loads (6, 10, 11, 12, 13, 14, 15), and, if necessary, the low voltage loads (7, 8, 9) depending on the settings determined by the driver such that the electrical energy that is at least one of producible and generated by the electric machine (1) is distributed between the high voltage battery (5), the high-voltage loads (6, 10, 11, 12, 13, 14, 15), and, if necessary, the low voltage loads so that the difference between the electrical energy that is at least one of producible and generated by the electric machine (1) and electrical energy consumed by the high voltage battery (5), the high voltage loads (6, 10, 11, 12, 13, 14, 15), and, if necessary, the low voltage loads (7, 8, 9) is minimized
